(19) United States
(12) Patent Application Publication
(10) Pub. No.: US 2007/0062771 A1
(43) Pub. Date: Mar. 22, 2007

(54) AN ELECTRICAL VEHICLE TRANSPORTATION SYSTEM

(76) Inventor: Dingzhong Li, Ridgewood, NY (US)

Correspondence Address: Shuang Zhang, 36-40 Main St., Suite 306, Flushing, NY, 11354, US

(21) Appl. No.: 11/162,640

(22) Filed: Sep. 17, 2005

(51) Int. Cl. B60L 5/04

(52) U.S. Cl. 191/50

(57) ABSTRACT

An improved electrically operated transportation vehicle and an electrified roadway over which the vehicle may operate and which supplies electric current to the vehicle are disclosed, in which hot power lines are located overhead of vehicles and neutral lines are deposited on the surface of the roadway. In addition, a high voltage AC line, extending continually along the roadway, is separated from a segmented low voltage AC or DC line. An improved electrical pickup is also disclosed to facilitate engagement and disengagement of a vehicle from a power supply line.

### BACKGROUND OF THE INVENTION

1. Field of the Invention

This invention relates to electrically operated transportation vehicle systems, and more particularly to an improved electrically operated transportation vehicle and an electrified roadway over which the vehicle may operate and which supplies electric current to the vehicle.

2. Description of the Prior Art

Vehicles, such as automobiles and trucks, have become indispensable tools of transportation for people. Based on different energy sources, vehicles were divided into two main categories: electrical vehicles and fuel-powered vehicles. The most commonly used fuels are gasoline and diesel oil. Although electrical powered vehicles were invented earlier, it was gasoline vehicles powered by an internal combustion engine that ushered in the age of modern automobiles.

Many factors have contributed to the popularity of gasoline-powered vehicles. Among them, ease of refueling and range of travel without refueling made it stand out from the competition and dominant in auto industry for over 80 years. However, pollutants derived from automobile operation have posed serious environmental problems. It has been calculated, for example, that 70% of the carbon monoxide, 45% of the nitrogen oxides, and 34% of the hydrocarbon pollution in the United States can be traced directly to automobile exhausts. One way to solve this problem is to develop electrically operated vehicles, which is zero exhaust emission. In addition, an electrically operated vehicle has other merits, such as absence of noise and ease of control.

There are several types of electrically operated vehicles. The first type is heavily dependent on outside power source in order for it to operate. One well-known example comprises electrically powered public transportation vehicles, such as trolley bus, which receive electrical power through overhead electrical cables. In this case, the vehicles have a very limited battery pack so that they are generally confined to the regions where the power cable is present and they have generally not been found on open roadways for general public use.

The second type of electrified vehicles employs a battery pack for its power supply. Due to the limitation of a battery capacity, a pure battery-operated vehicle typically has to reserve a huge portion of its weight for the battery pack. Even so, a pure battery-operated vehicle still suffers serious limitation in the distance it can travel between battery charges. Attempts at building viable battery-powered electric vehicles continued throughout the 1990s, but cost, speed and inadequate driving range made them uneconomical. Current research and development is centered on “hybrid” vehicles that use both electric power and internal combustion, which has a self-contained power source, such as an internal combustion engine, being provided to drive a generator for re-charging the batteries and/or providing electrical energy to the drive motors when not operating on the batteries.

The third type is a combination of the above two types of electrified vehicle transportation systems. The vehicles have their own battery packs and they are also able to receive electrical power through electrical conductors on or above the roadway. The battery packs included provide power when the vehicle is on open roadway and it is re-charged when the vehicle is on electric powered roadway. Among the prior art patents in this field are the following: U.S. Pat. No. 4,476,947, relating to an electrically powered vehicle transportation system where the roadway is energized in response to the presence of a vehicle having certain control systems and only when that vehicle satisfies certain predetermined conditions which provide safety features for foot traffic on the roadway system; U.S. Pat. No. 4,139,071, relating to a roadway having a smooth road surface for automotive vehicles including means for transmitting electric current through the road surface to electrically-operated vehicles; and U.S. Pat. No. 5,464,082, relating to an electrical vehicle transportation system in which a steerable electrically powered automotive vehicle receives electrical power from electrified conductors located above a roadway or affixed to the roadway, through an electrical pickup on the vehicle having electrical contacts engageable with the roadway conductors in a manner which permits steering movement of the vehicle laterally of the roadway and switching of the vehicle from one traffic lane to another with no interruption, or only momentary interruption, in the flow of electrical power to the vehicle. Although these patents have greatly improved this type of electrically operated transportation system, there are still some unanswered issues remaining, such as safety concern, installation and maintenance issue, and reduction of line loss during electricity transmission.

In addition, the traditional electrical pickup as seen on a trolley bus has some drawbacks, for instance, it is not easy to engage and disengage a vehicle with a power line and it does not allow other vehicles, which share the same power line, to pass by.

From the above, it is seen that the prior art electrically operated vehicle transportation systems have generally been inherently limited in some respects, which might have prevented their widespread acceptance. It is, therefore, the primary object of the present invention to provide an improved electrified transportation system including a new and improved electrically-operated automotive vehicle and electrified roadway over which the vehicle is operated and which will overcome the limitations of the prior art as discussed above.

Another object of the present invention is to provide an improved electrified roadway which has high safety evaluation.

Another object of the present invention is to provide an improved electrified roadway system which is easy to install, maintain and repair.

Another object of the present invention is to provide an improved electrified roadway system which has lower line loss during electricity transmission.

Another object of the present invention is to provide an improved electrified roadway which is easy for electrical vehicles to engage and disengage.

A further object of the invention is to provide an improved electric pickup system used on an electrical-operated vehicle to facilitate engagement and disengagement of the vehicle with an electrified roadway.

### SUMMARY OF THE INVENTION

In the attainment of the foregoing and other objects and advantages of the present invention, an important feature resides in providing an electrified roadway having a substantially smooth top road surface and including at least one overhead hot line extending longitudinally of traffic lanes and one neutral line disposed on the roadway.

Another important feature resides in providing an electrified roadway having discontinued conductive lines. Each independent conductive line connects with a continually extending electricity transmission power line.

Another important feature resides in providing an electrified roadway having converting means installed between each conductive line and electricity transmission power line, wherein the converting means converts high voltage alternating current (AC) in the electricity transmission power line into low voltage AC or low voltage direct current (DC) in the conductive line.

Another important feature resides in providing an electrified roadway having conductive line being shared between electrical vehicles traveling on different lanes.

Another important feature resides in providing an electrical vehicle having an improved electricity pickup means.

In the preferred embodiment of the invention chosen for illustration, the electrified roadway has at least one traffic lane, and at least one high voltage electricity transmission power line associated with the roadway and extending along and coextensive with the roadway. The power line is disposed in an overhead location above vehicles traveling on the roadway and a neutral line is disposed on the surface of the roadway.

In another preferred embodiment of the invention chosen for illustration, the electrified roadway has at least one traffic lane, and at least one high voltage electricity transmission power line associated with the roadway and extending along and coextensive with the roadway. The power line is disposed in an overhead location above vehicles traveling on the roadway. A conductive line connects with the power line through a converting means, which converts high voltage AC in the power line into low voltage AC in the conductive line. The conductive line is extending along with the power line but covers only certain length of roadway. A neutral line is disposed on the surface of the roadway. An electrical vehicle has an electric pickup engaging with the overhead conductive line and a contacting means engaging with the neutral line.

In another preferred embodiment of the invention chosen for illustration, the electrified roadway has at least one traffic lane, and at least one high voltage electricity transmission power line associated with the roadway and extending along and coextensive with the roadway. The power line is disposed in an overhead location above vehicles traveling on the roadway. A conductive line connects with the power line through a converting means, which converts high voltage AC in the power line into low voltage DC in the conductive line. The conductive line is extending along with the power line but covers only certain length of roadway. A neutral line is disposed on the surface of the roadway. An electrical vehicle has an electric pickup engaging with the overhead conductive line and a contacting means engaging with the neutral line.

The preferred embodiment of the electric pickup on an electrical vehicle is a contacting ring on top of an extendible stem structure.

To facilitate the engagement of an electrical pickup with a conductive line, the end of every segmented conductive line forms an upward arc structure in preferred embodiments.

### BRIEF DESCRIPTION OF THE DRAWINGS

Other objects and advantages of the invention will become apparent from the detailed description thereof contained hereinbelow, taken in conjunction with the drawings, in which:

FIG. 1 is a side view schematically illustrating an electrical vehicle on an electrified roadway according to the invention;

FIG. 2 is a side view schematically illustrating an electrical vehicle on an electrified roadway, which has converting means between electricity transmission power line and conductive line to convert high voltage AC into low voltage AC, according to the invention;

FIG. 3 is a side view schematically illustrating an electrical vehicle on an electrified roadway, which has converting means between electricity transmission power line and conductive line to convert high voltage AC into low voltage DC, according to the invention;

FIG. 4 is a perspective view schematically illustrating the electric pickup on an electrical vehicle according to the invention.

### DESCRIPTION OF THE PREFERRED EMBODIMENTS

In this invention, two conductive lines, through which an electrical vehicle receives outside electricity, are located separately. The hot line (or the charged line) is deposited at a position above vehicles traveling on the roadway and the neutral line is deposited on the surface of the roadway. This arrangement provides several advantages over prior arts: 1) elimination of potential hazard to foot travelers; 2) elimination of accidental short circuit, which may be caused by rain or other incidents; 3) elimination of strict positioning of the vehicle on the roadway in order to receive outside power. It also makes possible for vehicles on different lanes to share a hot line and/or a neutral line.

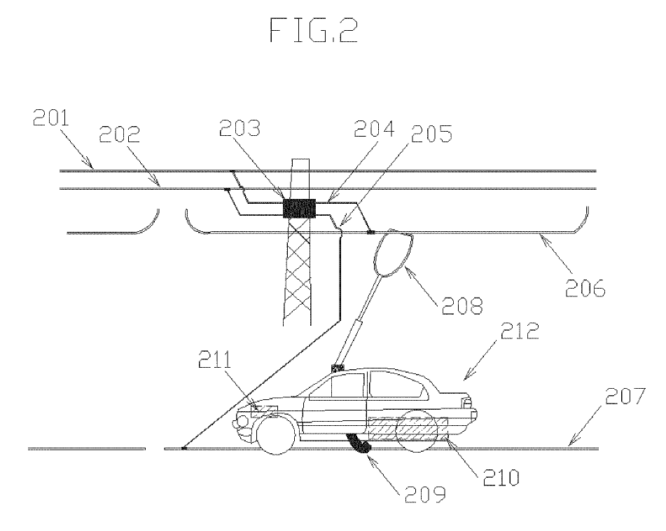

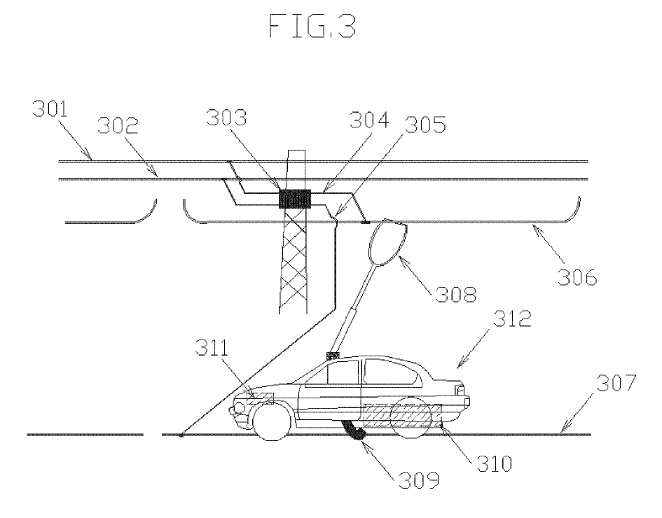

In the preferred embodiments disclosed in FIGS. 2 and 3, the hot lines connect with a nearby high voltage electricity-transmission line through a converting means. In this case, one hot line covers only a segment of a roadway. As a result, each hot line can be manipulated individually. The arrangement greatly facilitates installation, maintenance, diagnosis and repair processes.

In the preferred embodiments disclosed in FIGS. 2 and 3, the converting means connects a hot line and a high voltage electricity-transmission line together. The converting means comprises transformer and rectifier, through which high voltage AC in the transmission line is converted into low voltage DC in the hot line to supply power to electrical vehicles on this segment of road. A low voltage AC or DC is suitable for electrical vehicles; however, it is not good for long-range electricity transmission. Therefore, in this invention, a separated electricity-transmission line is used to carry high voltage electricity in order to reduce line loss over a long-range.

In this invention, the electrical vehicle contains DC or AC motors powered by its onboard batteries or outside electricity. The DC or AC motors are well known art in the field. In one instance, the outside electricity powers the motor through the onboard batteries. During travel of a vehicle on an electrified roadway, the stored electrical energy in the onboard batteries is utilized to power the vehicle motor while the batteries are being continuously recharged from the roadway conductors. Thus, the net battery charge is not consumed while traveling on an electrified roadway, but, instead, the batteries are maintained at or near full charge for travel on electrified roadways. In another instance, the outside electricity powers the motor independent of the onboard batteries. During travel of a vehicle on an electrified roadway, the outside electricity directly powers the motor and recharges the batteries. During travel of the vehicle on a non-electrified roadway, however, the onboard batteries provide power for the motor.

In this invention, a pickup on a vehicle inducts electricity from an overhead conductive line into the electrical vehicle; and an eduction means connects the vehicle with a neutral line on the surface of a roadway. Therefore, the pickup and the eduction means complete an electrical circuit between the conductive line and the vehicle. The electrical pickup includes mounting means for attachment to the vehicle, an electrical contact and means supporting the contacts on the mounting means. The contact is engageable with the conductive line and is movable along the conductive line with the vehicle. Similarly, the eduction means includes mounting means for attachment to the vehicle, an electrical contact and means supporting the contacts on the mounting means. The contact is engageable with the neutral line and is movable along the neutral line with the vehicle. In the preferred embodiments, a driver is able to control release and retraction of both pickup and eduction means.

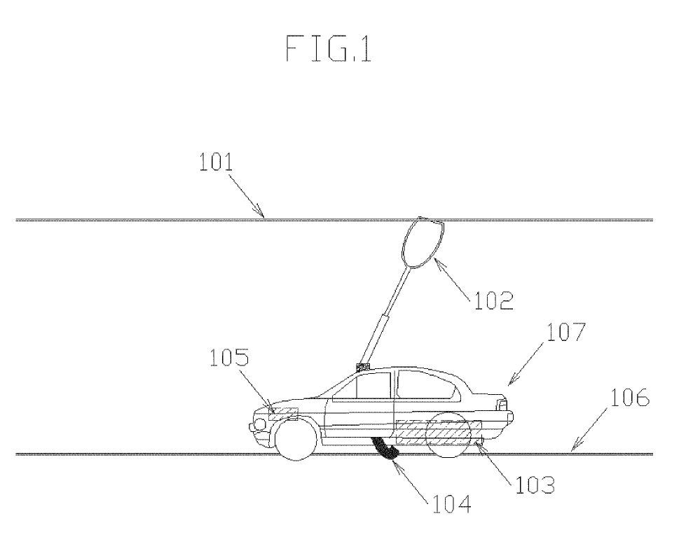

Referring now to FIG. 1 in detail, the illustrated electrified vehicle transportation system comprises a roadway having a high voltage electricity transmission power line 101 continually extending along the roadway, and electrical steerable vehicles 107. The power line 101, being the hot line, is located overhead of vehicles 107 traveling along the roadway. A neutral line 106 is deposited on the surface of the roadway. Electricity is generated by remote generators (not shown) and is carried by transmission lines 101.

Different power sources are been used to power vehicles on different roadways. During travel of the electrical vehicle on an electrified roadway, a driver releases the electricity pickup 102 and the eduction means 104 on the vehicle to form a circuit between the transmission powerline 101, the neutral line 106 and the vehicle 107 so that outside electricity is taken up to power the motor 105 and re-charge the onboard batteries 103. During travel of the vehicle on a non-electrified roadway, however, onboard batteries 103 are used to support the same motor 105 running.

Referring to FIG. 2, the illustrated electrified vehicle transportation system comprises a roadway having high voltage electricity transmission power lines continually extending along the roadway, segmental conductive lines, a converting means 203, and electrical steerable vehicles 212. The high voltage electricity transmission power line comprises at least one hot line 201 and at least one neutral line 202. The segmental conductive line comprises at least one hot line 206 and at least one neutral line 207. The hot line 206 is located overhead of vehicles 212 traveling along the roadway; and the neutral line 207 is deposited on the surface of the roadway. The converting means 203 comprises at least one transformer, which is able to convert high voltage AC in the hot line 201 into low voltage AC in a linking line 204. Through the line 204, low voltage AC is then transmitted to the hot conductive line 206. Electricity is generated by remote generators (not shown) and is carried by transmission lines 201. The neutral line 207 is connected to the neutral line 202 through a linking line 205.

Different power sources are been used to power vehicles on different roadways. During travel of the electrical vehicle on an electrified roadway, a driver releases the electricity pickup 208 and the eduction means 209 on the vehicle to form a circuit between the conductive line 206, the neutral line 207 and the vehicle 212 so that outside electricity is taken up to power the motor 211 and re-charge the onboard batteries 210. During travel of the vehicle on a non-electrified roadway, however, onboard batteries 210 are used to support the same motor 211 running.

Referring to FIG. 3, the illustrated electrified vehicle transportation system comprises a roadway having high voltage electricity transmission power lines continually extending along the roadway, segmental conductive lines, a converting means 303, and electrical steerable vehicles 312. The high voltage electricity transmission power line comprises at least one hot line 301 and at least one neutral line 302. The segmental conductive line comprises at least one hot line 306 and at least one neutral line 307. The hot line 306 is located overhead of vehicles 312 traveling along the roadway; and the neutral line 307 is deposited on the surface of the roadway. The converting means 303 comprises at least one transformer and one rectifier, which is able to convert high voltage AC in the hot line 301 into low voltage DC in a linking line 304. Through the line 304, low voltage DC is then transmitted to the hot conductive line 306. Electricity is generated by remote generators (not shown) and is carried by transmission lines 301. The neutral line 307 is connected to the neutral line 302 through a linking line 305.

Different power sources are been used to power vehicles on different roadways. During travel of the electrical vehicle on an electrified roadway, a driver releases the electricity pickup 308 and the eduction means 309 on the vehicle to form a circuit between the conductive line 306, the neutral line 307 and the vehicle 312 so that outside electricity is taken up to power the motor 311 and re-charge the onboard batteries 310. During travel of the vehicle on a non-electrified roadway, however, onboard batteries 310 are used to support the same motor 311 running.

In FIGS. 1-3, the eduction means could be an “S” shape metal flake, a rotatable metal wheel, a metal brush, or other forms. The technique behind is well known to people in this field of art.

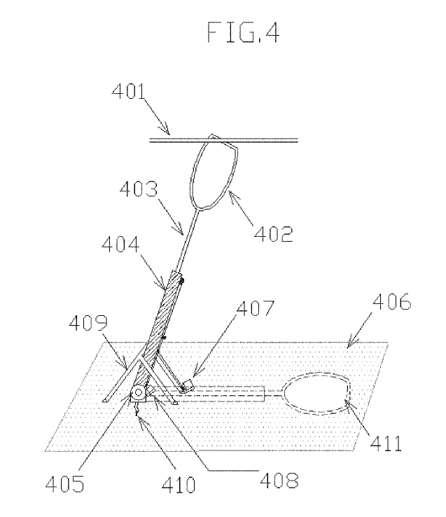

Referring to FIG. 4, the illustrated electrical pickup, sitting on top of a vehicle 406, comprises a contacting head 402, a protrudable arm 403, an insulation sheath 404, brackets 409, and motors 407/408. The motor 407 lifts the pickup from the resting position 411 to the working position in order for the contacting head 402 to make a firm engagement with an overhead conductive line 401. The motor 408 controls the extension of the arm 403. At the resting position 411, most part of the arm 403 stays inside of the insulation sheath 404; at the working position, it reaches out to help the contacting head 402 to make a firm engagement with an overhead conductive line 401. The wire 410 transmits electricity from the contacting head 402 to an electrical motor inside the vehicle (not shown).

To facilitate the engagement of an electrical pickup with a conductive line, the end of every segmented conductive line forms an upward arc structure, as shown in FIG. 2 and FIG. 3.

In this invention, an electrical vehicle refers to automobiles, buses, trucks or like, and other types of electrical propulsion system. For convenience, it is assumed that the vehicles are battery powered vehicles including electrical propulsion motors energized by storage batteries through appropriate driver operated controls, other standard vehicle operating elements, such as steering wheels, brakes, lights, and the like, not shown.

While I have disclosed and described preferred embodiments of my invention, I wish it understood that I do not intend to be restricted solely thereto, but rather that I do intend to include all embodiments thereof which would be apparent to one skilled in the art and which come within the spirit and scope of my invention.

What is claimed is:

1. An electrical vehicle transportation system, comprising:
1) an electrified roadway having at least one traffic lane, and at least one stationary electrical conductor means associated with the roadway and extending along and coextensive with the roadway, wherein each said conductor means comprising at least two conductive lines extending along said roadway, of which at least one said conductive line is disposed in an overhead location above vehicles on said roadway (overhead conductive line) and at least one said conductive line is disposed on the roadway (on-road conductive line),
2) a steerable electrically powered vehicle having wheels riding on said roadway for movement of said vehicle along and laterally of said roadway, comprising:
a. an electrical propulsion motor means,
b. a battery means,
c. an electrical pickup means, comprising a first electrical contact means on said vehicle contacting said overhead conductive line,
d. an eduction means, comprising a second electrical contact means on said vehicle contacting said on-road conductive line,
whereby said battery means is de-charged and said motor means operates on battery power when the pickup means is disengaged from said electrical conductor means, and said battery means is re-charged and said motor means operates on power from said electrical conductor means when the pickup means is engaged with said electrical conductor means.

2. The electrical vehicle transportation system as defined in claim 1, wherein said overhead conductive line is a hot line, which carries high voltage, and said on-road conductive line is a neutral line.

3. The electrical vehicle transportation system as defined in claim 1, wherein said electrically powered vehicle further comprises an outlet for re-charging said battery means with outside electrical power source.

4. The electrical vehicle transportation system as defined in claim 1, wherein said electrical pickup comprises at least one contacting head, at least one protrudable arm, at least one insulation sheath, at least one transmission wire, and moving means,
wherein said transmission wire transmits electricity from said contacting head to an electrical motor in a vehicle,
and wherein said moving means lifts said protrudable arm from a resting position to a working position in order for said contacting head to make a firm engagement with an overhead conductive line,
and wherein said moving means controls the extension of said arm so that at said resting position, said arm stays inside of said insulation sheath; at said working position, said arm reaches out to help said contacting head to make a firm engagement with an overhead conductive line.

5. An electrical vehicle transportation system, comprising:
1) an electrified roadway having at least one traffic lane, and at least one stationary electrical conductor means associated with the roadway and extending along and coextensive with the roadway, wherein each said conductor means comprising at least two conductive lines extending along said roadway, of which at least one said conductive line is disposed in an overhead location above vehicles on said roadway (overhead conductive line) and at least one said conductive line is disposed on the roadway (on-road conductive line), and said overhead conductive line is further connected with a high voltage electricity power line through a converting means, wherein said converting means converts high voltage alternating current (AC) from said power line into direct current (DC) at a voltage suitable for an electrically powered vehicle, and said on-road conductive line is a neutral line,
2) a steerable electrically powered vehicle having wheels riding on said roadway for movement of said vehicle along and laterally of said roadway, comprising:
a. an electrical propulsion motor means,
b. a battery means,
c. an electrical pickup means, comprising a first electrical contact means on said vehicle contacting said overhead conductive line,
d. an eduction means, comprising a second electrical contact means on said vehicle contacting said on-road conductive line,
whereby said battery means is de-charged and said motor means operates on battery power when the pickup means is disengaged from said electrical conductor means, and said battery means is re-charged and said motor means operates on power from said electrical conductor means when the pickup means is engaged with said electrical conductor means.

6. The electrical vehicle transportation system as defined in claim 5, wherein each end of said overhead conductive line forms an upward arc structure.

7. An electrical vehicle transportation system, comprising:
1) an electrified roadway having at least one traffic lane, and at least one stationary electrical conductor means associated with the roadway and extending along and coextensive with the roadway, wherein each said conductor means comprising at least two conductive lines extending along said roadway, of which at least one said conductive line is disposed in an overhead location above vehicles on said roadway (overhead conductive line) and at least one said conductive line is disposed on the roadway (on-road conductive line), and said overhead conductive line is further connected with a high voltage electricity power line through a converting means, wherein said converting means converts alternating current (AC) from said power line into a low voltage AC suitable for an electrically powered vehicle, and said on-road conductive line is a neutral line,
2) a steerable electrically powered vehicle having wheels riding on said roadway for movement of said vehicle along and laterally of said roadway, comprising:
a. an electrical propulsion motor means,
b. a battery means,
c. an electrical pickup means, comprising a first electrical contact means on said vehicle contacting said overhead conductive line,
d. an eduction means, comprising a second electrical contact means on said vehicle contacting said on-road conductive line,
whereby said battery means is de-charged and said motor means operates on battery power when the pickup means is disengaged from said electrical conductor means, and said battery means is re-charged and said motor means operates on power from said electrical conductor means when the pickup means is engaged with said electrical conductor means.

8. The electrical vehicle transportation system as defined in claim 7, wherein each end of said overhead conductive line forms an upward arc structure.
